(19) United States
(12) Patent Application Publication
(10) Pub. No.: US 2024/0064443 A1
(43) Pub. Date: Feb. 22, 2024

(54) SYSTEMS AND METHODS FOR FAST LINK BRINGUP

(71) Applicant: Mellanox Technologies, Ltd., Yokneam (IL)

(72) Inventors: Ioannis (Giannis) Patronas, Athens (GR); Paraskevas Bakopoulos, Ilion (GR); Dotan David Levi, Kiryat Motzkin (IL); Aviv Berg, Beit Keshet (IL); Wojciech Wasko, Mlynek (PL); Dimitrios Syrivelis, Volos (GR); Elad Mentovich, Tel Aviv (IL); Yoav Rozenberg, Haifa (IL); Nikolaos Argyris, Zografou (GR)

(21) Appl. No.: 17/948,930

(22) Filed: Sep. 20, 2022

(30) Foreign Application Priority Data
Aug. 17, 2022 (GR) 20220100695

(51) Int. Cl. H04Q 11/00

(52) U.S. Cl. CPC H04Q 11/0005; H04Q 11/0062; H04Q 2011/0007; H04Q 2011/0037; H04Q 2011/0064

(57) ABSTRACT

Systems, devices, and methods are described herein for reducing a link bringup time period for optical switching between network devices. An example method of the present disclosure receives an indication of a reconfiguration condition associated with an optical switch communicatively coupled to an optical communication channel and based on the reconfiguration condition, selects first data associated with a storage device or second data associated with a pattern generator device for transmission to a first network device. Selecting the first or second data may be based on a digital logic signal that indicates whether data is actively received from the second network device via the optical communication channel or may be based on a defined schedule for reconfiguring the optical switch.

### CROSS-REFERENCE TO RELATED APPLICATIONS

This application claims priority to Greek Patent Application No. 20220100695, filed Aug. 17, 2022, the entire contents of which application are hereby incorporated herein by reference.

### TECHNOLOGICAL FIELD

Example embodiments of the present disclosure relate generally to communication systems and, more particularly, to systems and methods for reducing the time required for bringing up links in an optical switching network.

### BACKGROUND

Communication systems leverage transmitters, receivers, switches, communication mediums (e.g., optical fibers, free space, etc.) and/or the like to communicably couple devices that form these communication systems. In some instances, optical switches may be used and feature optical input and output ports that may route the light that is coupled to their input ports to the intended output ports on demand, according to one or more control signals (electrical or optical). Applicant has identified a number of deficiencies and problems associated with conventional communication systems. Through applied effort, ingenuity, and innovation, many of these identified problems have been solved by developing solutions that are included in embodiments of the present disclosure, many examples of which are described in detail herein.

### BRIEF SUMMARY

Systems, apparatuses, methods, and computer program products are provided for reducing the time required for bringing up links in an optical switching network. With reference to an example system, an optical transceiver system may be configured to receive first data associated with a first bitstream from a first network device via an optical communication channel. The system may include a pattern generator device configured to generate second data associated with a second bitstream. The system may further include a data selector device configured to select, for transmission to a second network device, the first data associated with the first bitstream or the second data associated with the pattern generator device based on a reconfiguration condition associated with an optical switch communicatively coupled to the optical communication channel.

In some embodiments, the data selector device may be configured to select the first data associated with the first bitstream or the second data associated with the pattern generator device based on a digital logic signal that indicates whether data is actively received from the first network device via the optical communication channel.

In some embodiments, the data selector device may be configured to select the first data associated with the first bitstream or the second data associated with the pattern generator device based on a defined schedule for reconfiguring the optical switch.

In some embodiments, the data selector device may be configured to select the first data associated with the first bitstream or the second data associated with the pattern generator device based on an auto-sensing module configured to detect whether data is actively received from the first network device via the optical communication channel.

In some embodiments, the data selector device may be configured to select the first data associated with the first bitstream or the second data associated with the pattern generator device based on a status of a first-in, first-out (FIFO) buffer employed to convert a first clock domain for the first bitstream into a second clock domain.

In some embodiments, the system may further include a cross domain clocking (CDC) device configured to convert a first clock domain for the first bitstream into a second clock domain. In such an embodiment, the data selector device may be configured to transmit the first data associated with the first bitstream or the second data associated with the pattern generator device to the second network device based on the second clock domain.

In some embodiments, the system may further include a lookup table (LUT) device configured to store one or more frequency equalizer tap values associated with cross domain clocking for the first bitstream.

In some embodiments, the system may further include a serializer/deserializer (SerDes) device configured to convert the first bitstream received from the first network device into a de-serialized bitstream. In such an embodiment, the system may further include a cross domain clocking (CDC) device configured to convert a first clock domain for the de-serialized bitstream into a second clock domain and a storage device that may be configured to store one or more portions of the de-serialized bitstream associated with the second clock domain.

In some embodiments, the system may further include a bitstream processing device configured for receiving data processing associated at least one of frame recognition, word alignment, error correction, data scrambling, or decoding with respect to the first bitstream received from the first network device via the optical communication channel.

In some embodiments, the first bitstream may be transmitted with a pilot tone signal associated with a defined frequency, and the system may further include a block synchronization device configured to mix the first bitstream with the pilot tone signal.

In some embodiments, the optical communication channel may include a multimode optical fiber. In such embodiments, the first bitstream may be transmitted via a first core of the multimode optical fiber and the pilot tone may transmitted via a second core of the multimode optical fiber.

In some embodiments, the optical communication channel may include a plurality of optical fibers. In such embodiments, the first bitstream may be transmitted via a first optical fiber and the pilot tone may be transmitted via a second optical fiber.

In some embodiments, the system may include a digital coherent module, where the digital coherent module includes a local oscillator and may be configured to mix the local oscillator, the first bitstream, and the pilot tone signal using the defined frequency.

In some embodiments, the digital coherent module may be configured to synchronize a sampling rate of an analog-to-digital convertor with the pilot tone signal.

In another aspect, the present disclosure provides an optical transceiver apparatus including at least one processor and a memory storing instructions that may be operable, when executed by the processor, to cause the optical transceiver apparatus to receive an indication of a reconfiguration condition associated with an optical switch communicatively coupled to the optical communication channel and based on the reconfiguration condition, select first data associated with a bitstream, where the bitstream may be received from a first network device via the optical communication channel, or second data associated with a pattern generator device for transmission to a second network device.

In some embodiments, the apparatus may further include instructions that are operable, when executed by the processor, to cause the optical transceiver apparatus to select the first data associated with the bitstream or the second data associated with the pattern generator device for the transmission to the second network device based on a digital logic signal that indicates whether data is actively received from the first network device via the optical communication channel.

In some embodiments, the apparatus may further include instructions that are operable, when executed by the processor, to cause the optical transceiver apparatus to select the first data associated with the bitstream or the second data associated with the pattern generator device for the transmission to the second network device based on a defined schedule for reconfiguring the optical switch.

In some embodiments, the apparatus may further include instructions that are operable, when executed by the processor, to cause the optical transceiver apparatus to select the first data associated with the storage device or the second data associated with the pattern generator device for the transmission to the first network device based on a status of a first-in, first-out (FIFO) buffer employed to convert a first clock domain for the bitstream into a second clock domain.

In some embodiments, the apparatus may further include instructions that are operable, when executed by the processor, to cause the optical transceiver apparatus to convert a first clock domain for the bitstream into a second clock domain and transmit the first data associated with the bitstream or the second data associated with the pattern generator device to the second network device based on the second clock domain.

In some embodiments, the apparatus may further include instructions that are operable, when executed by the processor, to cause the optical transceiver apparatus to convert the bitstream received from the first network device into a de-serialized bitstream; convert a first clock domain for the de-serialized bitstream into a second clock domain; and store one or more portions of the de-serialized bitstream associated with the second clock domain in a data storage device.

In another aspect, the present disclosure may include a method for reducing a link bringup time period for optical switching between network devices. The method may include receiving an indication of a reconfiguration condition associated with an optical switch communicatively coupled to an optical communication channel and based on the reconfiguration condition, selecting first data associated with a bitstream, where the bitstream is received from a first network device via the optical communication channel, or second data associated with a pattern generator device for transmission to a second network device.

In some embodiments, selecting the first data associated with the storage device or the second data associated with the pattern generator device may further include selecting the first data associated with the bitstream or the second data associated with the pattern generator device based on a digital logic signal that indicates whether data is actively received from the first network device via the optical communication channel.

In some embodiments, selecting the first data associated with the storage device or the second data associated with the pattern generator device may further include selecting the first data associated with the bitstream or the second data associated with the pattern generator device based on a defined schedule for reconfiguring the optical switch.

In some embodiments, the method may include converting a first clock domain for the bitstream into a second clock domain and transmitting the first data associated with the first bitstream or the second data associated with the pattern generator device to the first network device based on the second clock domain.

The features, functions, and advantages that have been discussed may be achieved independently in various embodiments of the present disclosure or may be combined with yet other embodiments, further details of which may be seen with reference to the following description and drawings.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIG. 1 illustrates an optical switch reconfiguration with which a fast link bringup operation may be implemented, in accordance with an embodiment of the present disclosure;

FIG. 2 illustrates a system environment for fast link bringup, in accordance with an embodiment of the present disclosure;

FIG. 3 is a flow chart illustrating an example method for data transmission in an optical network, in accordance with an embodiment of the present disclosure; and

FIG. 4 is a flowchart illustrating an example method for clock forwarding, in accordance with an embodiment of the present disclosure.

### DETAILED DESCRIPTION

Embodiments of the present disclosure will now be described more fully hereinafter with reference to the accompanying drawings, in which some, but not all, embodiments of the disclosure are shown. Indeed, the embodiments of the present disclosure may include many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described above, optical switches feature optical input and output ports and are capable of routing light that is coupled to their input ports to the intended output ports on demand, according to one or more control signals (electrical or optical). The routing of the signals is performed in the optical domain (i.e., without the need for optical-electrical and electrical-optical conversion), thus bypassing the need for power-consuming transceivers. Header processing and buffering of the data is not possible in the optical domain and thus, packet switching (as it is realized in conventional networks that leverage electrical switches) cannot be employed. Instead, the circuit switching paradigm is used in which an end-to-end circuit is created for the communication between two devices. Most current optical switching networks follow a TDMA (Time Division Multiple Access) approach, where time is divided in slots with guardbands between each slot. The duration of the slots and the guardbands is dictated mainly by the reconfiguration capabilities of the optical switch and the time required for bringing up the links.

Every time an optical switch changes its configuration, the existing links are destroyed and then re-created from scratch. Thus, every time the switch connects different endpoints (e.g., a DPU, NIC, Switch, baseboard or the like), a period of time is needed for link bringup. During the reconfiguration of the optical switches and the link bringup periods, the endpoints cannot transmit useful data since the network is not operational. As such, the embodiments of the present disclosure as described herein may solve these issues and others by providing a pattern generator device and a data selector device which may select particular data of respective first or second bitstreams for transmission to a network device based on a reconfiguration condition. The reconfiguration condition may be associated with an optical switch communicatively coupled to an optical communication channel.

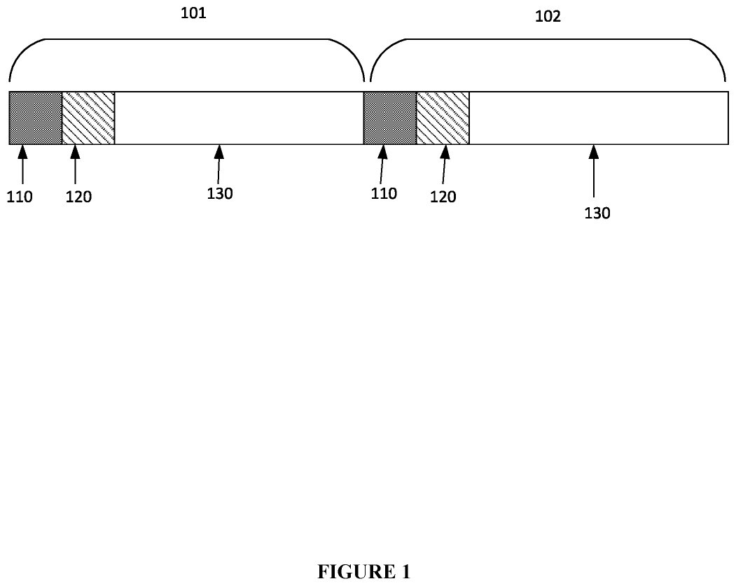

With reference to FIG. 1, an example slotted operation during an optical switch reconfiguration is illustrated. As shown, the operation may include two (2) example time periods, time 101 and time 102. Time 101 represents a first optical switch configuration, and time 102 represents a second optical switch configuration. Blocks 130 represent “useful” time periods, or time periods during which data is regularly transmitted between transceivers. Blocks 110 and 120 represent overhead periods, or time periods during which useful data cannot be transmitted between transceivers. Specifically, blocks 110 represent switch reconfiguration times, while blocks 120 represent link bringup time. As described hereinafter, the embodiments of the present disclosure are directed to systems and methods for reducing the link bringup time 120, such that an overall latency (overhead periods) is reduced, thereby enhancing network performance.

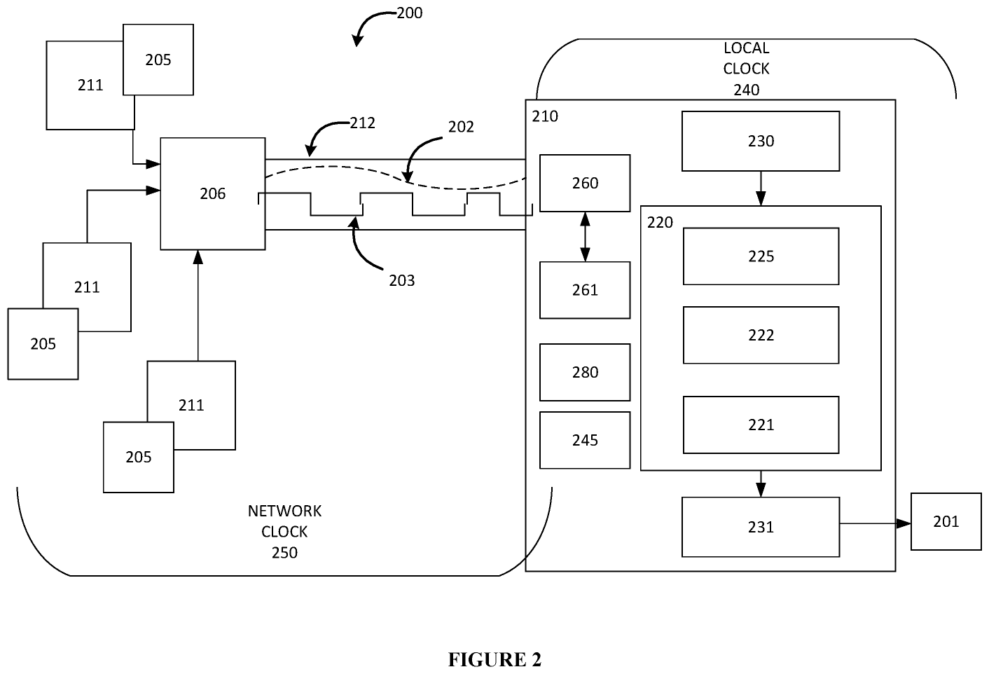

With reference to FIG. 2, a system environment 200 for fast link bringup is illustrated. As shown, the system 200 may be an optical communication system configured to transmit optical signals 202 between pairs of transceivers. In some embodiments, the system 200 may be a self-homodyne optical system, wherein a pilot tone 203 is transmitted with each optical signal 202. The system includes a transceiver 210, which may be a pluggable transceiver, mid-board transceiver, co-packaged transceiver, or the like. The system may further include a plurality of corresponding transceivers 211, wherein each transceiver of the plurality of corresponding transceivers 211 is operatively coupled to one of a plurality of endpoint network devices 205. At any point in time, the transceiver 210 may be paired with one transceiver of the plurality of corresponding transceivers 211 via an optical communication channel 212. The optical communication channel 212 may include a fiber optic cable or any other optical medium through which optical signals are propagated. The system may further include an optical switch 206, configured to change the pairings between the transceiver 210 and the plurality of corresponding transceivers 211. The transceiver 210 may be an adapter for the optical communication channel 212 and may be configured to convert optical signals received from the optical communication channel 212 into electrical signals for use by a network device. The transceiver 210 may further include a physical coding sublayer (PCS layer) 220 and a serializer/deserializer (SERDES) device 230.

The serializer/deserializer (SERDES) device 230 may be configured to receive a serial bitstream from the optical communication channel 212 and convert the serial bitstream into a de-serialized bitstream, or a parallel bus. The SERDES device 230 may de-serialize a bitstream using a variety of known techniques, such a serial clock recovery technique or a reference clock technique, and may use an embedded clock architecture, parallel clock architecture, bit interleaved architecture, or 8b/10b architecture. The SERDES device 230 may be operatively coupled to the transceiver 210 or may be a fully integrated component of the transceiver 210. The SERDES device 230 may be configured to transmit a parallel bus to the PCS layer 220 for data processing. In some embodiments, the system 200 may include a second SERDES device 231, which may be configured to serialize a parallel bus into a serialized bitstream using a variety of known techniques. The second SERDES device 231 may transmitted the serialized bitstream to the host device 201.

The system 200 may further include two or more clock domains, including a local clock 240 and a network clock 250. The local clock 240 may be a shared clock between the transceiver 210 and a host device 201 and may be linked to a local clock server. The network clock 250 may be associated with at least one of the plurality of corresponding transceivers 211, such that if a different corresponding transceiver 211 is used in the system 200, the network clock 250 may change to a different network clock 250 associated with the different corresponding transceiver 211. In some embodiments, such as when the system 200 is part of a network employing a synchronization scheme, the local clock 240 and network clock 250 may be substantially identical.

The PCS layer 220 may be configured to perform a variety of functions depending on a system design, system protocol, and/or other system requirements. For example, the PCS layer 220 may include a bitstream processing device 225 configured to perform functions such as forward and backward error correction, scrambling and descrambling functions, 64b/66b encoding and decoding, elastic buffering, signal multiplexing and demultiplexer, frame recognition, word alignment, and/or the like. Furthermore, the PCS layer 230 may be configured to perform a clock domain crossing (CDC) operation between the network clock 250 and the local clock 240. In some embodiments, a clock domain for the parallel bus may be the network clock 250 and the CDC operation may convert the clock domain for the parallel bus to the local clock 240. In some embodiments, the PCS layer 220 may further include a pattern generator device 221 and a multiplexer device, or auto-sensing module 222.

The auto-sensing module 222 may be configured to, during an optical reconfiguration period, select the pattern generator device 221 and cause the pattern generator device 221 to transmit data to the host device 201. Additionally or alternatively, the auto-sensing module 222 may be configured to select the pattern generator device 221 and cause the pattern generator device 221 to transmit data to the host device 201 when the SERDES device 230 is not receiving a serial bitstream. Furthermore, the auto-sensing module 222 may be configured to select the pattern generator device 221 and cause the pattern generator device 221 to transmit data to the host device 201 on a predetermined schedule, by checking a status of the CDC operation, or by receiving any other digital logic signal. The PCS layer 220 may be further configured to perform an elastic buffer function. The elastic buffer function may be any clock compensation technique suitable to compensate for frequency differences between the network clock 250 and local clock 240.

In some embodiments, the transceiver 210 may include a lookup table (LUT) device 261. The LUT device 261 may store, for each transceiver of the plurality of corresponding transceivers 211, an associated phase offset value. Phase offset values may be empirically determined during a network initialization operation and may be periodically updated. When establishing communication with a new corresponding transceiver 211, the transceiver 210 may be configured to lookup, using the LUT device 261, the associated phase offset value for the new corresponding transceiver 21. The transceiver 210 may apply the phase offset value such that received data from the corresponding transceiver 211 remains stable during a link bringup period. Furthermore, the LUT device 261 may store, for each transceiver of the plurality of corresponding transceivers 211, an associated amplitude offset value. Amplitude offset values may be empirically determined during a network initialization operation and may be periodically updated. When establishing communication with a new corresponding transceiver 211, the transceiver 210 may be configured to lookup, using the LUT device 261, the associated amplitude offset value for the new corresponding transceiver 21. Additionally or alternatively, the transceiver 210 may include an optical equalizer device 262 (such as a variable gain optical amplifier) configured to apply the amplitude offset value such that received data from the corresponding transceiver 211 remains stable during a link bringup period.

In some embodiments, the LUT device 261 may store a frequency equalizer tap value for each transceiver of the plurality of corresponding transceivers 211. Frequency equalizer tap values may be calculated using a variety of filter algorithms, such as a least mean squares (LMS) algorithm. Frequency equalizer tap values may be calculated during a network initialization operation and may be periodically corrected and/or updated.

The transceiver 210 may be configured to receive a pilot tone signal 203. In some embodiments, the pilot tone 203 may be transmitted in orthogonal polarization with an optical signal 202 via the optical communication channel 212. In other embodiments, the optical communication channel 212 may include a plurality of fiber cores and the pilot tone 203 and optical signal 202 may be transmitted via different fiber cores. The pilot tone 203 may be a pulsed or modulated signal and may be configured to carry clock information (i.e., may be configured to operate as a local oscillator). For example, a repetition rate and phase of the pilot tone 203 may be locked to a same repetition rate and phase of the optical signal 202. In some embodiments, wavelength division multiplexing may be used to simultaneously transmit a plurality of optical signal/pilot tone pairs across an optical communication channel 212.

The transceiver 210 may further include an analog-to-digital converter (ADC) device 260. The ADC device 260 may be configured to convert a continuous signal, such as an optical signal, into a digital logic signal by sampling a value at a predetermined sampling rate. Each phase offset stored by the LUT device 261 may be configured such that an instantaneous power value of the pilot tone 203 may be constant at each sampling point of the ADC device 270. In some embodiments, the ADC device 260 may collect one sample at each peak of a pilot tone pulse. Additionally or alternatively, the ADC device 260 may take collect (2) or more samples at each peak.

The transceiver 210 may further include a polarization tracker or block synchronization device 280 configured to mix the optical signal 202 with the pilot tone 203. Additionally or alternatively, the transceiver may comprise a digital coherent module (not illustrated), which may include a local oscillator 245 and may configured to mix the optical signal 202 with the pilot tone 203 and the local oscillator 245, using a pulse rate of the pilot tone 203 as a mixing reference. The digital coherent module may be configured to synchronize the sampling rate of the ADC device 260 with the pilot tone 203.

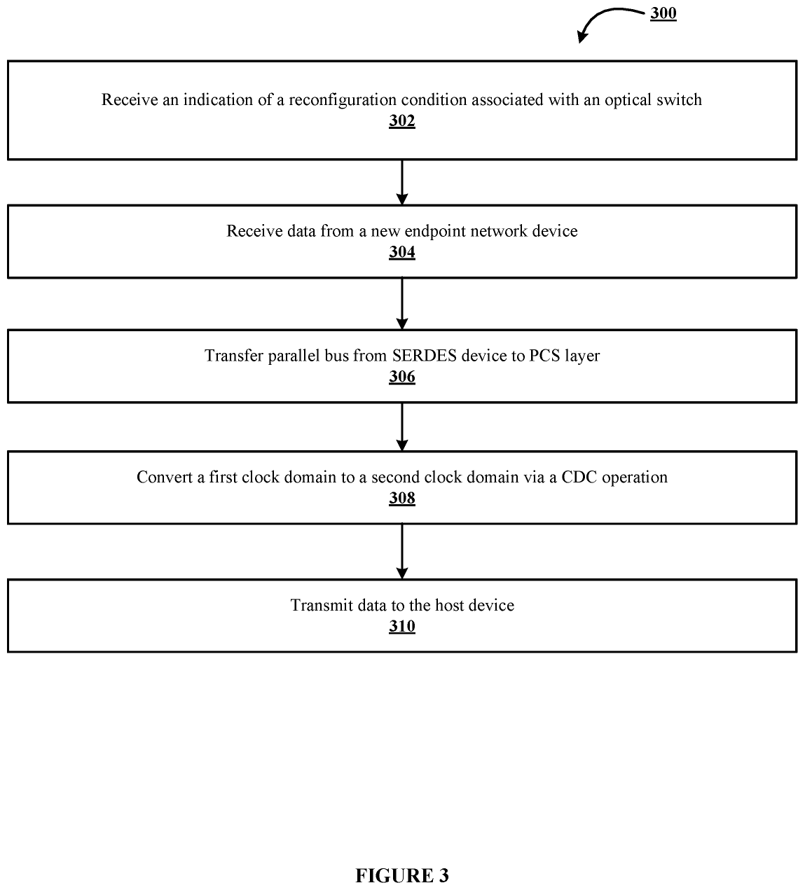

With reference to FIG. 3, a method 300 for data transmission is illustrated. The method 300 of FIG. 3 is described hereafter as performed by, in whole or in part, the system 200. The method may begin in block 302 where the transceiver 210 receives an indication of a reconfiguration condition associated with the optical switch 206 in the optical communication system 200. The reconfiguration condition may occur any time the optical switch 206 begins receiving data from a new endpoint network device 205, such as a data processing unit, network interface card, switch, baseboard, or the like. In some embodiments, reconfiguration conditions may occur on a fixed schedule. Additionally or alternatively, the reconfiguration condition may be indicated by a digital logic signal of the system, such as a signal from the block synchronization device 280.

Thereafter, the method may continue to block 304 where the system receives data from the new endpoint network device 205. The data may be received via an optical communication channel 212 with a transceiver 211 associated with the new endpoint network device 205. The data may be received as a serial bitstream. Then, the SERDES device 230 may be used to convert the serial bitstream into a de-serialized bitstream, or a parallel bus. The SERDES device may de-serialize the bitstream using a variety of techniques, such as a serial clock recovery technique or a reference clock technique, and may use an embedded clock architecture, parallel clock architecture, bit interleaved architecture, or 8b/10b architecture.

Thereafter, the method may continue to block 306 where the parallel bus is transferred from the SERDES device to the PCS layer 220. At the PCS layer 220, the bitstream processing device 225 may perform data processing functions such as frame recognition, word alignment, error correction, data scrambling, and/or decoding of the parallel bus.

Thereafter, the method may continue to block 308 where a clock domain for the bitstream is converted from a first clock domain to a second clock domain by a CDC operation of the PCS layer 230. In some embodiments, the CDC operation may be a first-in first-out (FIFO) buffer. The first clock domain may be network clock 250 associated with the endpoint network device 205 or a corresponding transceiver 211 of the endpoint network device. In some embodiments, the network clock 250 may change on a per timeslot basis. The second clock domain may be a local clock 240, wherein the local clock is stable and shared between the transceiver 210 and the host network device 201. In some embodiments, the PCS layer 220 may perform an elastic buffer function to compensate for frequency differences between the network clock 250 and the local clock 240. In some embodiments, the local clock 240 and the network clock 250 may be substantially identical, and the CDC operation may not be performed. Next, the bitstream may be stored by the storage device 226.

Thereafter, the method may continue to block 310 where the transceiver 210 may transmit data to the host device 101. The transmitted data may be the bitstream stored by the storage device 226 or may be a second data stream associated with the pattern generator device 221, depending on a digital logic signal from the auto-sensing module 222. The auto-sensing module 222 may select the bitstream or the second data stream for transmission based on receiving an indication of a reconfiguration condition, based on a predetermined schedule, and/or based on another digital logic signal from the system 200.

The method 300 may include additional embodiments, such as any single embodiment or any combination of embodiments described below and/or in connection with one or more other processes described elsewhere herein. Although FIG. 3 shows example blocks of method 300, in some embodiments, method 300 may include additional blocks, fewer blocks, different blocks, or differently arranged blocks than those depicted in FIG. 3. Additionally, or alternatively, two or more of the blocks of method 300 may be performed in parallel.

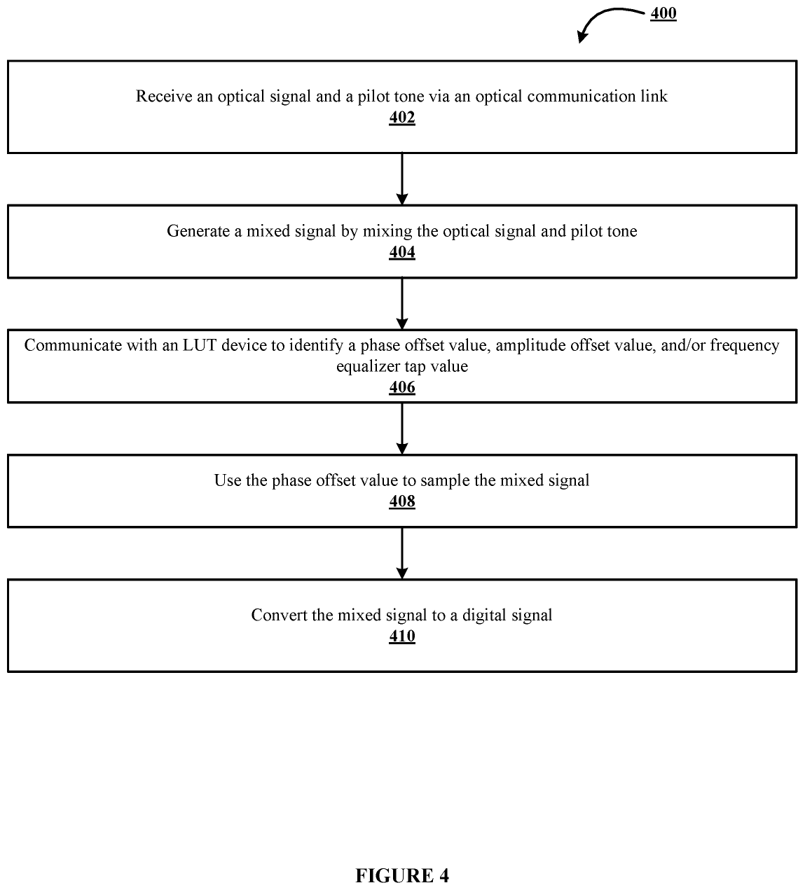

FIG. 4 illustrates a method 400 for clock forwarding in the system 200, in accordance with an embodiment of the present disclosure. In some embodiments, one or more controllers, one or more servers, network control and management software, one or more network management systems, and/or the like (e.g., similar to one or more of the systems described herein with respect to FIG. 2) may perform one or more of the steps of method 400.

The method may begin at block 402 where the transceiver 210 receives an optical signal 202 and a pilot tone 203 from a corresponding transceiver 211 via the optical communication channel 212. The pilot tone 203 may be a pulsed signal wherein a pulse repetition rate and phase are locked to a pulse repetition rate and phase of the optical signal 202. In some embodiments, the pilot tone 203 and the optical signal 202 may be transmitted via orthogonal polarization via the optical communication channel. In other embodiments, the optical communication channel 212 may comprise a multicore fiber, where an optical fiber includes a plurality of cores such that multiple signals can be transmitted simultaneously along different cores of the optical fiber. In such embodiments, the pilot tone 203 and the optical signal 202 may be transmitted via different cores of the multicore fiber in the optical communication channel 212. In such embodiments, the polarization states of the pilot tone 203 and the optical signal 202 may be arbitrary. In other embodiments, the optical communication channel 212 may comprise a plurality of optical fibers, and the pilot tone 203 and the optical signal 202 may be transmitted to the transceiver 211 via different optical fibers of the optical communication channel 212. Additionally or alternatively, multiple pairs of optical signals 202 and associated pilot tones 203 may be transmitted simultaneously via a wavelength division multiplexing (WDM) technique.

The method may continue to block 404 where a polarization tracker device or block synchronization device 280 generates a mixed signal by mixing the optical signal 202 with the pilot tone 203, using the pulse rate of the pilot tone 203 as a mixing reference. The method may then continue to block 406 where the ADC device 260 may communicate with the LUT device 261 to identify a phase offset value, amplitude offset value, and frequency tap value associated with the corresponding transceiver 211. The phase offset value, amplitude offset value, and frequency tap values may then be applied to the mixed signal. Moving on to block 408, the ADC device 260 may use the phase offset value to sample the mixed signal at constant power values of a pilot tone pulse, such that an instantaneous power value of the mixed signal is constant at each sampling point. In some embodiments, the ADC device 260 may sample the mixed signal at each peak of pilot tone pulse such that each sample reflects a maximum power value. The ADC device 260 may then use the samples to convert the mixed signal into a digital signal (shown at block 410), which may then be processed further by the transceiver 210 in accordance with the method of FIG. 4. The method of FIG. 4 may be repeated continuously as the transceiver 210 receives transmissions via the optical communication channel 212.

The method 400 may include additional embodiments, such as any single embodiment or any combination of embodiments described above and/or in connection with one or more other processes described elsewhere herein. Although FIG. 4 shows example blocks of method 400, in some embodiments, the method 400 may include additional blocks, fewer blocks, different blocks, or differently arranged blocks than those depicted in FIG. 4. Additionally, or alternatively, two or more of the blocks of method 400 may be performed in parallel.

As will be appreciated by one of ordinary skill in the art in view of this disclosure, the present disclosure may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present disclosure may take the form of an entirely business method embodiment, an entirely software embodiment (including firmware, resident software, micro-code, stored procedures in a database, or the like), an entirely hardware embodiment, or an embodiment combining method, software, and hardware aspects that may generally be referred to herein as a “system.” Furthermore, embodiments of the present disclosure may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as, for example, a propagation signal including computer-executable program code portions embodied therein.

One or more computer-executable program code portions for carrying out operations of the present disclosure may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F#.

Some embodiments of the present disclosure are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory) that may direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present disclosure.

Although many embodiments of the present disclosure have just been described above, the present disclosure may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

No element, act, or instruction used herein should be construed as critical or essential unless explicitly described as such. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

While certain exemplary embodiments have been described and shown in the accompanying drawings, it is to be understood that such embodiments are merely illustrative of and not restrictive on the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the disclosure. Therefore, it is to be understood that, within the scope of the appended claims, the disclosure may be practiced other than as specifically described herein.

What is claimed is:

1. An optical transceiver system configured to receive first data associated with a first bitstream from a first network device via an optical communication channel, the optical transceiver system comprising:
a pattern generator device configured to generate second data associated with a second bitstream; and
a data selector device configured to select, for transmission to a second network device, the first data associated with the first bitstream or the second data associated with the pattern generator device based on a reconfiguration condition associated with an optical switch communicatively coupled to the optical communication channel.

2. The optical transceiver system of claim 1, wherein the data selector device is configured to select the first data with the first bitstream or the second data associated with the pattern generator device based on a digital logic signal that indicates whether data is actively received from the first network device via the optical communication channel.

3. The optical transceiver system of claim 1, wherein the data selector device is configured to select the first data associated with the first bitstream or the second data associated with the pattern generator device based on a defined schedule for reconfiguring the optical switch.

4. The optical transceiver system of claim 1, wherein the data selector device is configured to select the first data associated with the first bitstream or the second data associated with the pattern generator device based on an auto-sensing module configured to detect whether data is actively received from the first network device via the optical communication channel.

5. The optical transceiver system of claim 1, wherein the data selector device is configured to select the first data associated with the first bitstream or the second data associated with the pattern generator device based on a status of a first-in, first-out (FIFO) buffer employed to convert a first clock domain for the first bitstream into a second clock domain.

6. The optical transceiver system of claim 1, further comprising:
a cross domain clocking (CDC) device configured to convert a first clock domain for the first bitstream into a second clock domain,
wherein the data selector device is configured to transmit the first data associated with the first bitstream or the second data associated with the pattern generator device to the second network device based on the second clock domain.

7. The optical transceiver system of claim 5, further comprising:
a lookup table (LUT) device configured to store one or more frequency equalizer tap values associated with cross domain clocking for the first bitstream.

8. The optical transceiver system of claim 1, further comprising:
a serializer/deserializer (SerDes) device configured to convert the first bitstream received from the first network device into a de-serialized bitstream;
a cross domain clocking (CDC) device configured to convert a first clock domain for the de-serialized bitstream into a second clock domain; and
a storage device configured to store one or more portions of the de-serialized bitstream associated with the second clock domain.

9. The optical transceiver system of claim 1, further comprising:
a bitstream processing device configured for data processing associated at least one of frame recognition, word alignment, error correction, data scrambling, or decoding with respect to the first bitstream received from the first network device via the optical communication channel.

10. The optical transceiver system of claim 1, wherein the first bitstream is transmitted with a pilot tone signal associated with a defined frequency, the optical transceiver system further comprising:
a block synchronization device configured to mix the first bitstream with the pilot tone signal.

11. The optical transceiver system of claim 10, wherein the optical communication channel comprises a multimode optical fiber, wherein:
the first bitstream is transmitted via a first core of the multimode optical fiber; and
the pilot tone is transmitted via a second core of the multimode optical fiber.

12. The optical transceiver system of claim 10, wherein the optical communication channel comprises a plurality of optical fibers, wherein the first bitstream is transmitted via a first optical fiber and the pilot tone is transmitted via a second optical fiber.

13. The optical transceiver system of claim 10, further comprising a digital coherent module, wherein the digital coherent module comprises a local oscillator and is configured to mix the local oscillator, the first bitstream, and the pilot tone signal using the defined frequency.

14. The optical transceiver of claim 13, wherein the digital coherent module is configured to synchronize a sampling rate of an analog-to-digital convertor with the pilot tone signal.

15. An optical transceiver apparatus comprising at least one processor and a memory storing instructions that are operable, when executed by the processor, to cause the optical transceiver apparatus to:
receive an indication of a reconfiguration condition associated with an optical switch communicatively coupled to the optical communication channel; and
based on the reconfiguration condition, select first data associated with a bitstream, wherein the bitstream is received from a first network device via the optical communication channel, or second data associated with a pattern generator device for transmission to a second network device.

16. The transceiver apparatus of claim 15, further comprising instructions that are operable, when executed by the processor, to cause the optical transceiver apparatus to select the first data associated with the bitstream or the second data associated with the pattern generator device for the transmission to the second network device based on a digital logic signal that indicates whether data is actively received from the first network device via the optical communication channel.

17. The transceiver apparatus of claim 15, further comprising instructions that are operable, when executed by the processor, to cause the optical transceiver apparatus to select the first data associated with the bitstream or the second data associated with the pattern generator device for the transmission to the second network device based on a defined schedule for reconfiguring the optical switch.

18. The transceiver apparatus of claim 15, further comprising instructions that are operable, when executed by the processor, to cause the optical transceiver apparatus to select the first data associated with the bitstream or the second data associated with the pattern generator device for the transmission to the second network device based on a status of a first-in, first-out (FIFO) buffer employed to convert a first clock domain for the bitstream into a second clock domain.

19. The transceiver apparatus of claim 15, further comprising instructions that are operable, when executed by the processor, to cause the optical transceiver apparatus to:
convert a first clock domain for the bitstream into a second clock domain; and
transmit the first data associated with the bitstream or the second data associated with the pattern generator device to the second network device based on the second clock domain.

20. The transceiver apparatus of claim 15, further comprising instructions that are operable, when executed by the processor, to cause the optical transceiver apparatus to:
convert the bitstream received from the first network device into a de-serialized bitstream;
convert a first clock domain for the de-serialized bitstream into a second clock domain; and
store one or more portions of the de-serialized bitstream associated with the second clock domain in a data storage device.

21. A method for reducing a link bringup time period for optical switching between network devices, the method comprising:
receiving an indication of a reconfiguration condition associated with an optical switch communicatively coupled to an optical communication channel; and
based on the reconfiguration condition, selecting first data associated with a bitstream, wherein the bitstream is received from a first network device via the optical communication channel, or second data associated with a pattern generator device for transmission to a second network device.

22. The method of claim 21, wherein selecting the first data associated with the bitstream or the second data associated with the pattern generator device comprises selecting the first data associated with the bitstream or the second data associated with the pattern generator device based on a digital logic signal that indicates whether data is actively received from the first network device via the optical communication channel.

23. The method of claim 21, wherein selecting the first data associated with the storage device or the second data associated with the pattern generator device comprises selecting the first data associated with the bitstream or the second data associated with the pattern generator device based on a defined schedule for reconfiguring the optical switch.

24. The method of claim 21, further comprising:
converting a first clock domain for the bitstream into a second clock domain; and
transmitting the first data associated with the storage device or the second data associated with the pattern generator device to the second network device based on the second clock domain.
